(19) United States
(12) Patent Application Publication
(10) Pub. No.: US 2026/0129325 A1
(43) Pub. Date: May 7, 2026

(54) VIBRATION TRANSMISSION PLATES, LOUDSPEAKER ASSEMBLIES, AND BONE-CONDUCTION EARPHONES

(71) Applicant: SHENZHEN SHOKZ CO., LTD., Shenzhen (CN)

(72) Inventors: Junjiang FU, Shenzhen (CN); Shuai LIU, Shenzhen (CN)

(73) Assignee: SHENZHEN SHOKZ CO., LTD., Shenzhen (CN)

(21) Appl. No.: 19/433,949

(22) Filed: Dec. 28, 2025

Related U.S. Application Data
(63) Continuation of application No. PCT/CN2024/102587, filed on Jun. 28, 2024.

(51) Int. Cl. H04R 1/10; H04R 9/02; H04R 9/04; H04R 9/06

(52) U.S. Cl. CPC H04R 1/1008; H04R 1/1075; H04R 9/025; H04R 9/045; H04R 9/06; H04R 2460/13

(57) ABSTRACT

The present disclosure relates to a vibration transmission plate, a loudspeaker assembly, and a bone-conduction earphone. The vibration transmission plate includes an inner ring body, an outer ring body, a first connecting rod, and a second connecting rod. The inner ring body includes a first inner ring edge including two first straight line segments and two first curved segments. The outer ring body includes a first outer ring edge including two second straight line segments and two second curved segments. The first connecting rod includes a first inner connecting portion, a first outer connecting portion, and a straight extending portion located within a straight gap. The second connecting rod includes a second inner connecting portion, a second outer connecting portion, and a curved extending portion located within a curved gap.

### CROSS-REFERENCE TO RELATED APPLICATIONS

This application is a Continuation of International Patent Application No. PCT/CN2024/102587, filed on Jun. 28, 2024, the entire contents of which are incorporated herein by reference.

### TECHNICAL FIELD

The present disclosure relates to the technical field of electronic devices, and in particular, to a vibration transmission plate, a loudspeaker assembly, and a bone-conduction earphone.

### BACKGROUND

With the increasing prevalence of electronic devices, they have become indispensable tools for social interaction and entertainment, while user expectations for such devices continue to rise. Electronic devices such as earphones can be used in conjunction with terminal devices such as mobile phones and computers to deliver an enhanced auditory experience, and have thus become widely integrated into daily life. Conventional bone-conduction earphones are typically equipped with a magnetic circuit and an electric circuit that interact through electromagnetic induction, enabling the earphones to vibrate and achieve bone conduction. A vibration transmission plate is typically provided to couple the magnetic circuit and the electric circuit, so as to relatively constrain their positions. However, during the relative movement between the magnetic circuit and the electric circuit, the vibration transmission plate is susceptible to damage, deformation, or even fracture.

### SUMMARY

The present disclosure provides a vibration transmission plate, a loudspeaker assembly, and a bone-conduction earphone, which can increase the stiffness of the vibration transmission plate and improve the reliability and service life of the vibration transmission plate.

On the one hand, the present disclosure provides a vibration transmission plate, comprising an inner ring body, an outer ring body surrounding the inner ring body, and a first connecting rod and a second connecting rod connected between the inner ring body and the outer ring body. The inner ring body includes a first inner ring edge adjacent to the outer ring body, and the first inner ring edge includes two first straight line segments and two first curved segments, the two first straight line segments are arranged side by side and opposite to each other, and the two first curved segments are respectively connected to adjacent ends of the two first straight line segments and protrude toward an outside of the vibration transmission plate. The outer ring body includes a first outer ring edge adjacent to the inner ring body, and the first outer ring edge includes two second straight line segments respectively located outside the two first straight line segments and two second curved segments respectively located outside the two first curved segments, such that a straight gap is formed between each pair of adjacent first straight line segment and second straight line segment, and a curved gap is formed between each pair of adjacent first curved segment and second curved segment. The first connecting rod includes a first inner connecting portion connected to the first inner ring edge, a first outer connecting portion connected to the first outer ring edge, and a straight extending portion connected between the first inner connecting portion and the first outer connecting portion and located within the straight gap. The second connecting rod includes a second inner connecting portion connected to the first inner ring edge, a second outer connecting portion connected to the first outer ring edge, and a curved extending portion connected between the second inner connecting portion and the second outer connecting portion and located within the curved gap.

In some embodiments, there are two first connecting rods and two second connecting rods, and the two first connecting rods and the two second connecting rods are 180 degrees rotationally symmetrical relative to a centroid or center of mass of the inner ring body.

In some embodiments, the first inner connecting portion is adjacent to the second outer connecting portion, and the first outer connecting portion is adjacent to the second inner connecting portion.

In some embodiments, the first curved segment, the second curved segment, and an inner edge and an outer edge of the curved extending portion are arranged in circular arc shapes with a common center of a circle, and the first straight line segment, the second straight line segment, and an inner edge and an outer edge of the straight extending portion are arranged parallel to each other.

In some embodiments, an inner edge of the curved extending portion is arranged in a circular arc shape, an inner edge of the second inner connecting portion includes a first circular arc segment that connects the first inner ring edge and a second circular arc segment that connects the first circular arc segment and the inner edge of the curved extending portion, a ratio of a diameter of the first circular arc segment to a diameter of the inner edge of the curved extending portion is in a range of 0.02 to 0.03, a ratio of a diameter of the second circular arc segment to the diameter of the inner edge of the curved extending portion is in a range of 0.11 to 0.14, and the first circular arc segment and the second circular arc segment are concave arcs.

In some embodiments, an outer edge of the second inner connecting portion includes a third circular arc segment that connects the first inner ring edge and a fourth circular arc segment that connects the third circular arc segment and an outer edge of the curved extending portion, a ratio of a diameter of the third circular arc segment to the diameter of the inner edge of the curved extending portion is in a range of 0.16 to 0.2, a ratio of a diameter of the fourth circular arc segment to the diameter of the inner edge of the curved extending portion is in a range of 0.16 to 0.2, the third circular arc segment is a concave arc, and the fourth circular arc segment is a convex arc.

In some embodiments, the diameter of the fourth circular arc segment is the same as the diameter of the third circular arc segment.

In some embodiments, a ratio of a straight-line distance from a connection point between the first circular arc segment and the first inner ring edge to a connection point between the third circular arc segment and the first inner ring edge to a width of the curved extending portion is in a range of 2.65 to 3.25.

In some embodiments, the second inner connecting portion is adjacent to the first outer connecting portion, an outer edge of the first outer connecting portion includes a fifth circular arc segment that connects the first outer ring edge and a sixth circular arc segment that connects the fifth circular arc segment and an outer edge of the straight extending portion, a ratio of a diameter of the fifth circular arc segment to the diameter of the inner edge of the curved extending portion is in a range of 0.02 to 0.03, a ratio of a diameter of the sixth circular arc segment to the diameter of the inner edge of the curved extending portion is in a range of 0.11 to 0.14, and the fifth circular arc segment and the sixth circular arc segment are concave arcs.

In some embodiments, the diameter of the fifth circular arc segment is the same as the diameter of the first circular arc segment, and the diameter of the sixth circular arc segment is the same as the diameter of the second circular arc segment.

In some embodiments, an inner edge of the first outer connecting portion includes a seventh circular arc segment that connects the first outer ring edge and an eighth circular arc segment that connects the seventh circular arc segment and an inner edge of the straight extending portion, a connection line between a center of a circle of the fourth circular arc segment and a center of a circle of the eighth circular arc segment has a midpoint, an angle formed between a connection line between the midpoint and a center of a circle of the inner edge of the curved extending portion and a spacing direction between the two first straight line segments is in a range of 8 degrees to 18 degrees, the seventh circular arc segment is a concave arc, and the eighth circular arc segment is a convex arc.

In some embodiments, the angle is in a range of 11 degrees to 15 degrees.

In some embodiments, a ratio of a connection length between the center of the circle of the fourth circular arc segment and the center of the circle of the eighth circular arc segment to a width of the curved extending portion or a width of the straight extending portion is in a range of 3.71 to 4.54.

In some embodiments, the width of the curved extending portion is in a range between the width of the straight extending portion and a width of the inner ring body.

In some embodiments, a ratio of a diameter of the seventh circular arc segment to the diameter of the inner edge of the curved extending portion is in a range of 0.16 to 0.2, and a ratio of a diameter of the eighth circular arc segment to the diameter of the inner edge of the curved extending portion is in a range of 0.16 to 0.2.

In some embodiments, the diameters of the third circular arc segment, the fourth circular arc segment, the seventh circular arc segment, and the eighth circular arc segment are the same.

In some embodiments, a straight-line distance from a connection point between the fifth circular arc segment and the first outer ring edge to a connection point between the seventh circular arc segment and the first outer ring edge is greater than a straight-line distance from a connection point between the first circular arc segment and the first inner ring edge to a connection point between the third circular arc segment and the first inner ring edge.

In some embodiments, a ratio of the straight-line distance from the connection point between the fifth circular arc segment and the first outer ring edge to the connection point between the seventh circular arc segment and the first outer ring edge to a width of the straight extending portion is in a range of 3.17 to 3.88.

In some embodiments, a connection between the first connecting rod and the first inner ring edge and a connection between the first connecting rod and the first outer ring edge are smooth transition connections; and a connection between the second connecting rod and the first inner ring edge and a connection between the second connecting rod and the first outer ring edge are smooth transition connections.

On the other hand, the present disclosure provides a loudspeaker assembly, comprising a transducer device. The transducer device includes a voice coil, a bracket, a magnetic circuit system, and the vibration transmission plate described above. The inner ring body of the vibration transmission plate is connected to the bracket, the outer ring body of the vibration transmission plate is connected to the magnetic circuit system to elastically suspend the magnetic circuit system on a periphery of the bracket, and the voice coil is arranged on the bracket.

On the other hand, the present disclosure provides a bone-conduction earphone, comprising the vibration transmission plate described above.

The present disclosure brings the following beneficial effect. Different from the prior art, the present disclosure provides the first connecting rod and the second connecting rod connected between the inner ring body and the outer ring body; the first connecting rod is arranged in the straight gap between the inner ring body and the outer ring body, and the first connecting rod is provided with the straight extending portion corresponding to the straight gap as well as the linear shapes of the inner ring body and the outer ring body; the second connecting rod is arranged in the curved gap between the inner ring body and the outer ring body, and the second connecting rod is provided with the curved extending portion corresponding to the curved gap as well as the curved shapes of the inner ring body and the outer ring body. Therefore, the cooperative design of the first connecting rod and the second connecting rod corresponding to the shapes of the inner ring body and the outer ring body allows the inner ring body to move relative to the outer ring body while maintaining the sensitivity of their relative movement, and at the same time increases lateral stiffness, so that the first connecting rod and the second connecting rod are less likely to fracture, thereby improving the reliability of the vibration transmission plate and enhancing its service life.

### BRIEF DESCRIPTION OF THE DRAWINGS

FIG. 1 is a schematic diagram illustrating an overall structure of a bone-conduction earphone according to one embodiment of the present disclosure;

FIG. 2 is a schematic diagram illustrating an overall structure of a loudspeaker assembly according to the present disclosure;

FIG. 3 is a schematic diagram illustrating an overall structure of a transducer device according to the present disclosure;

FIG. 4 is a schematic diagram illustrating an exemplary sectional structure of the transducer device shown in FIG. 2 along A-A;

FIG. 5 is a schematic diagram illustrating an overall structure of a vibration transmission plate according to one embodiment of the present disclosure;

FIG. 6 is a schematic diagram illustrating an enlarged view of a region Q in the vibration transmission plate shown in FIG. 5;

FIG. 7 is a schematic diagram illustrating another overall structure of the vibration transmission plate shown in FIG. 5;

FIG. 8 is a schematic diagram illustrating a stress distribution of the vibration transmission plate shown in FIG. 5 when subjected to a load along a length direction;

FIG. 9 is a schematic diagram illustrating a stress distribution of the vibration transmission plate shown in FIG. 5 when subjected to a load along a width direction;

FIG. 10 is a schematic diagram illustrating a stress distribution of the vibration transmission plate shown in FIG. 5 when subjected to a load along an axial direction.

FIG. 11 is a schematic diagram illustrating another stress distribution of the vibration transmission plate shown in FIG. 5 when subjected to a load along an axial direction; and

FIG. 12 is a schematic diagram illustrating a stress distribution of the vibration transmission plate shown in FIG. 5 under a torsional load along a width direction.

### DETAILED DESCRIPTION

The present disclosure is described in further detail below in conjunction with the accompanying drawings and embodiments. In particular, it is noted that the following embodiments are only used to illustrate the present disclosure, but do not limit the scope of the present disclosure. Similarly, the following embodiments are only part of the embodiments of the present disclosure rather than all of the embodiments, and all other embodiments obtained by a person of ordinary skill in the art without creative labor fall within the scope of protection of the present disclosure. The following embodiments are only some, but not all, of the embodiments of the present disclosure.

References to “embodiments” in the present disclosure imply that particular features, structures, or characteristics described in conjunction with the embodiments may be included in at least one embodiment of the present disclosure. It is understood by those of skill in the art, both explicitly and implicitly, that the embodiments described in the present disclosure may be combined with other embodiments.

The following is an exemplary description of a bone-conduction earphone according to embodiments of bone-conduction earphones.

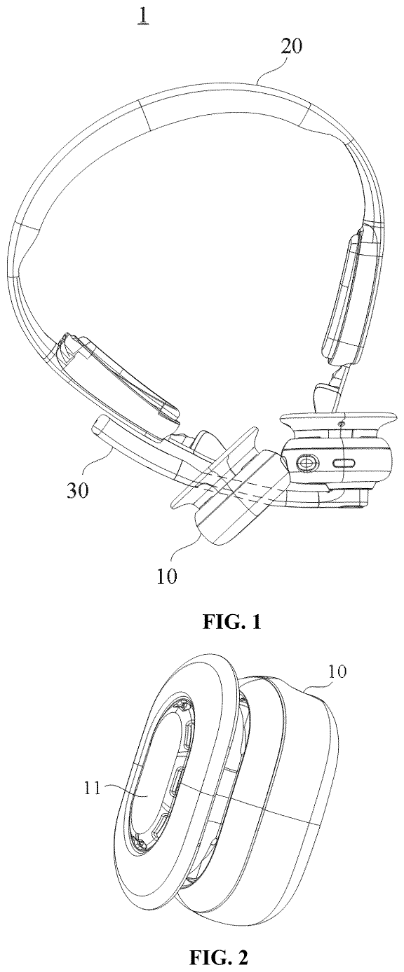

Bone-conduction earphone 1 is an earphone capable of generating bone-conduction sound by means of bone-conduction vibrations and conducting the bone-conduction sound to a user. Optionally, as shown in FIG. 1, the bone-conduction earphone 1 include a loudspeaker assembly 10, and the loudspeaker assembly 10 may be placed in a facial region in front of tragus of the left ear and/or right ear of a user, and fit the facial region of the user. The loudspeaker assembly 10 is used to convert an electrical signal containing relevant audio information into air-conduction sound and/or into bone-conduction sound, which is further conducted to the user by conducting the bone-conduction sound to the user.

In some embodiments, the bone-conduction earphone 1 further include a wearing assembly 20 and a boom microphone assembly 30. Two loudspeaker assemblies 10 may be provided. One of the two loudspeaker assemblies 10 is placed in the facial region on the front side of the tragus of the user's left ear for transmitting bone-conduction sound and/or air-conduction sound to the user's left ear, and the other of the two loudspeaker assemblies 10 is placed in the facial region on the front side of the tragus of the user's right ear for transmitting bone-conduction sound and/or air-conduction sound to the user's right ear.

The wearing assembly 20 may be connected to each of the two loudspeaker assemblies 10. The wearing assembly 20 may position each of the loudspeaker assemblies 10 in the facial region on the front side of the user's tragus. The two loudspeaker assemblies 10 may be the same or different. For example, one loudspeaker assembly 10 may be provided with the boom microphone assembly 30, and the other loudspeaker assembly 103 may not be provided with the boom microphone assembly 30. For example, one loudspeaker assembly 10 is used to deliver bone-conduction sound to the user, while the other loudspeaker assembly 103 is used to deliver air-conduction sound to the user.

In some embodiments, as shown in FIG. 2, the loudspeaker assembly 10 includes a transducer device 11. The transducer device 11 is the primary device in the loudspeaker assembly 10 for converting the electrical signal into bone-conduction sound.

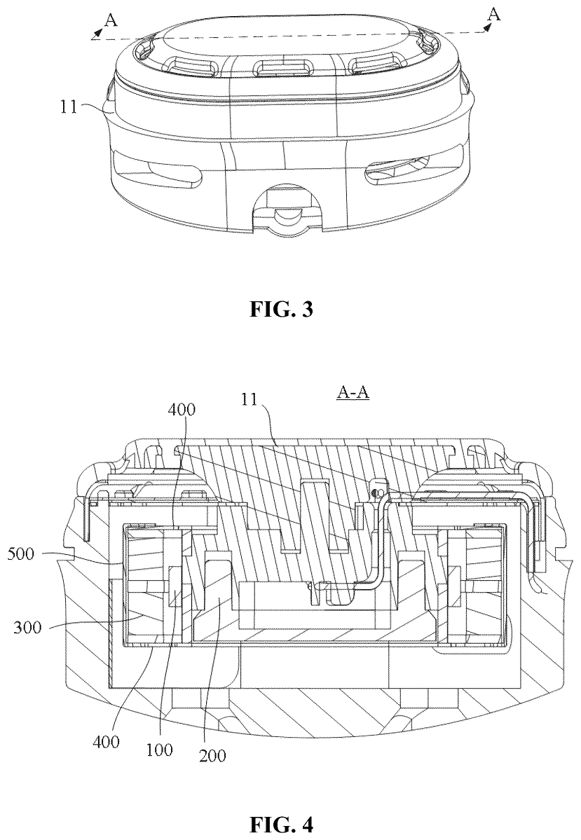

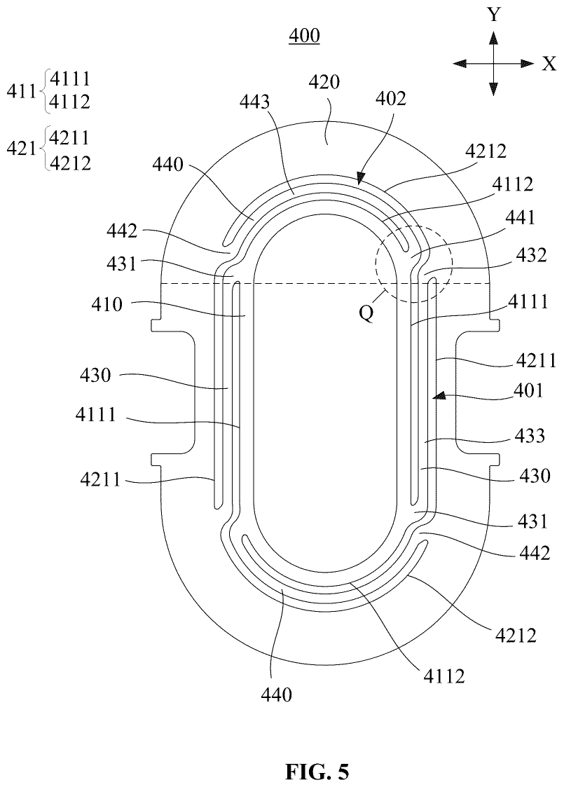

Optionally, the transducer device 11 includes a voice coil 100, a bracket 200, a magnetic circuit system 300, and a vibration transmission plate 400, as shown in FIG. 3 and FIG. 4. The vibration transmission plate 400 connects the bracket 200 and the magnetic circuit system 300 to elastically suspend the magnetic circuit system 300 on a periphery of the bracket 200, and the voice coil 100 is arranged on the bracket 200 to cooperate with the magnetic circuit system 300. Specifically, the magnetic circuit system 300 may drive the voice coil 100 and the bracket 200 to vibrate together when the voice coil 100 is connected to an electrical signal containing relevant audio information.

The voice coil 100 is capable of accessing the electrical signal containing relevant audio information, and the bracket 200 may be arranged inside the magnetic circuit system 300. The voice coil 100 may be secured to the bracket 200 by winding along a radial direction of the bracket 200. The voice coil 100 corresponds to the magnetic circuit system 300 to enable an electric field of the voice coil 100 when accessing the electrical signal containing relevant audio information to interact with a magnetic field of the magnetic circuit system 300. Understandably, the radial direction of the bracket 200 may be perpendicular to the vibration direction of the bracket 200, and in some scenarios, when interfered with the user or other objects, an angle greater than 0 degree and less than 90 degrees may be formed between the radial direction of the bracket 200 and the vibration direction of the bracket 200.

Specifically, since the voice coil 100 is opposite to the magnetic circuit system 300 along the radial direction of the transducer device 11, the electric field of the voice coil 100 and the magnetic field of the magnetic circuit system 300 are capable of interacting with each other so that an electromagnetic reaction occurs, causing the magnetic circuit system 300 and the bracket 200 on which the voice coil 100 is arranged to move relative to each other, so as to cause the transducer device 11 to vibrate and generate bone-conduction sound capable of conveying relevant audio information.

The vibration transmission plate 400 is capable of undergoing a certain amount of elastic deformation under the action of an external force, and is capable of reverting to its original shape after the external force is withdrawn. Since the vibration transmission plate 400 is connected to the bracket 200 and the magnetic circuit system 300, respectively, when the magnetic circuit system 300 and the voice coil 100 move relative to each other, the magnetic circuit system 300 and the bracket on which the voice coil 100 is arranged move relative to each other. At the same time, the vibration transmission plate 400 can elastically constrain the magnetic circuit system 300 and the bracket 200 on which the voice coil 100 is arranged to constrain the bracket 200 to the magnetic circuit system 300, so that an operation of the transducer device 11 can remain stable.

In some embodiments, the vibration transmission plate 400 may be made of a metallic material, which may include, but is not limited to, steel (e.g., stainless steel, carbon steel, etc.), lightweight alloys (e.g., aluminum alloys, beryllium copper, magnesium alloys, titanium alloys, etc.). In some embodiments, the vibration transmission plate 400 may also be made from other single or composite materials that can achieve the same performance. For example, the composite material may include, but is not limited to, reinforcing materials such as glass fibers, carbon fibers, boron fibers, graphite fibers, silicon carbide fibers, or aramid fibers.

In some embodiments, as shown in FIG. 5, the vibration transmission plate 400 includes an inner ring body 410, an outer ring body 420 surrounding the inner ring body 410, a first connecting rod 430, and a second connecting rod 440. The first connecting rod 430 and the second connecting rod 440 are connected between the inner ring body 410 and the outer ring body 420.

The inner ring body 410 of the vibration transmission plate 400 is connected to the bracket 200, the outer ring body 420 is connected to the magnetic circuit system 300, and the first connecting rod 430 and the second connecting rod 440 are both connected to the inner ring body 410 and the outer ring body 420. When the bracket 200 and the magnetic circuit system 300 move relative to each other, the first connecting rod 430 and the second connecting rod 440 undergo elastic deformation, which can support the inner ring body 410 and the outer ring body 420 to move relative to each other while restraining the inner ring body 410 and the outer ring body 420, so that the bracket 200 and the magnetic circuit system 300 are less likely to disengage from each other. However, the first connecting rod 430 and the second connecting rod 440 are also therefore subjected to a greater tensile force.

Specifically, as shown in FIG. 5, the inner ring body 410 includes a first inner ring edge 411 adjacent to the outer ring body 420, and the first inner ring edge 411 includes two first straight line segments 4111 and two first curved segments 4112. The two first straight line segments 4111 are arranged side by side and opposite to each other. The two first curved segments 4112 are respectively connected to adjacent ends of the two first straight line segments 4111 and protrude toward an outside of the vibration transmission plate 400. The outer ring body 420 includes a first outer ring edge 421 adjacent to the inner ring body 410, and the first outer ring edge 421 includes two second straight line segments 4211 and two second curved segments 4212. The two second straight line segments 4211 are respectively located outside the two first straight line segments 4111, and the two second curved segments 4212 are respectively located outside the two first curved segments 4112, such that a straight gap 401 is formed between each pair of adjacent first straight line segment 4111 and second straight line segment 4211, and a curved gap 402 is formed between each pair of adjacent first curved segment 4112 and second curved segment 4212.

The first connecting rod 430 and the second connecting rod 440 are both capable of being connected to the inner ring body 410 at one end and the outer ring body 420 at the other end, so that the first connecting rod 430 and the second connecting rod 440 can be more firmly connected to the inner ring body 410 and the outer ring body 420 when the inner ring body 410 and the outer ring body 420 move relative to each other driven by the bracket 200 and the magnetic circuit system 300.

Specifically, as shown in FIG. 5, the first connecting rod 430 includes a first inner connecting portion 431 connected to the first inner ring edge 411, a first outer connecting portion 432 connected to the first outer ring edge 421, and a straight extending portion 433 connected between the first inner connecting portion 431 and the first outer connecting portion 432 and located within the straight gap 401.

As shown in FIG. 5, the second connecting rod 440 includes a second inner connecting portion 441 connected to the first inner ring edge 411, a second outer connecting portion 442 connected to the first outer ring edge 421, and a curved extending portion 433 connected between the second inner connecting portion 441 and the second outer connecting portion 442 and located within the curved gap 401.

The first connecting rod 430 corresponds to the first straight line segment 4111 and the second straight line segment 4211, and the second connecting rod 440 corresponds to the first curved segment 4112 and the second curved segment 4212, and such a configuration can reduce the influence of the first connecting rod 430 and the second connecting rod 440 on the relative movement between the inner ring body 410 and the outer ring body 420, thereby maintaining the sensitivity of the relative movement between the inner ring body 410 and the outer ring body 420 when they moves relative to each other. As a result, the effectiveness of bone-conducted sound transmission via the bone-conduction vibration in the bone conduction earphone 1 can be improved. At the same time, the stiffness of the vibration transmission plate 400 along the radial direction (i.e., the direction perpendicular to the thickness direction of the vibration transmission plate 400 as shown in FIG. 5) can also be increased, so that the first connecting rod 430 and the second connecting rod 440 are less likely to break, thereby improving the reliability and service life of the vibration transmission plate 400.

In some embodiments, as shown in FIG. 5, there may be two first connecting rods 430 and two second connecting rods 440, and the two first connecting rods 430 and the two second connecting rods 440 are 180 degrees rotationally symmetrical relative to a centroid or center of mass of the inner ring body 410. In other words, the two first connecting rods 430 and the two second connecting rods 440 are spaced apart from each other along the circumferential direction of the inner ring body 410. The two first connecting rods 430 are arranged opposite to each other along a spacing direction between the two first straight line segments 4111 and the two second connecting rods 440 are arranged opposite to each other along a spacing direction between the two first curved segments 4112. The spacing direction between the two first straight line segments 4111 is a direction as shown by the X-arrow in FIG. 5, and the spacing direction between the two first curved segments 4112 is a direction as shown by the Y-arrow in FIG. 5. The direction shown by the X-arrow and the direction shown by the Y-arrow may be radially perpendicular to the vibration transmission plate 400.

The two first connecting rods 430 may correspond to the two first straight line segments 4111 and the two second straight line segments 4211, and the two second connecting rods 440 may correspond to the two first curved segments 4112 and the two second curved segments 4212, such a configuration can make the connection between the inner ring body 410 and the outer ring body 420 more stable, thereby increasing the stiffness of the vibration transmission plate 400 and improving the reliability and service life of the vibration transmission plate 400.

In some embodiments, as shown in FIG. 5, the first inner connecting portion 431 and the second outer connecting portion 442 are adjacent to each other along the circumferential direction of the vibration transmission plate 400, and the first outer connecting portion 432 and the second inner connecting portion 441 are adjacent to each other along the circumferential direction of the vibration transmission plate 400.

The first connecting rod 430 is connected to the first inner ring edge 411 through the first inner connecting portion 431 and connected to the first outer ring edge 421 through the first outer connecting portion 432, and the second connecting rod 440 is connected to the first outer ring edge 421 through the second outer connecting portion 442 and connected to the first inner ring edge 411 through the second inner connecting portion 441. This can make the first inner connecting portion 431 and the second inner connecting portion 441 that are connected to the inner ring body 410 to be as far away as possible without being adjacent to each other, and the first outer connecting portion 432 and the second outer connecting portion 442 that are connected to the outer ring body 420 to be as far away as possible without being adjacent to each other. In this way, when the inner ring body 410 and the outer ring body 420 move relative to each other, they can be pulled and constrained by the first connecting rod 430 and the second connecting rod 440. As a result, stress concentration at connections where the inner ring body 410 and the outer ring body 420 are respectively connected to the first connecting rod 430 and the second connecting rod 440 can be reduced, thereby decreasing the likelihood of fracture of the vibration transmission plate 400 and improving the reliability of the vibration transmission plate 400.

In some embodiments, as shown in FIG. 5, the first curved segment 4112, the second curved segment 4212, and an inner edge and an outer edge of the curved extending portion 443 are arranged in circular arc shapes with a common center of a circle. The first straight line segment 4111, the second straight line segment 4211, and an inner edge and an outer edge of the straight extending portion 433 are arranged parallel to each other.

Specifically, two ends of each of the first straight line segments 4111 are connected to the two first curved segments 4112, respectively, and two ends of each of the second straight line segments 4211 are connected to the two second curved segments 4212, respectively, so that the inner ring body 410 and the outer ring body 420 present an elliptical runway shape.

The first curved segment 4112, the second curved segment 4212, and the inner edge and the outer edge of the curved extending portion 443 are arranged in circular arc shapes with a common center of a circle, and the first straight line segment 4111, the second straight line segment 4211, and the inner edge and the outer edge of the straight extending portion 433 are arranged parallel to each other. Such a configuration can enable the curved extending portion 443 and the straight extending portion 4211 to be less likely contact with the inner ring body 410 and the outer ring body 420 during the relative movement between the inner ring body 410 and the outer ring body 420, thereby increasing the sensitivity of the relative movement between the inner ring body 410 and the outer ring body 420 and increasing the stiffness of the vibration transmission plate 400. In this way, the curved extending portion 443 and the straight extending portion 433 are less likely to be damaged during the relative movement between the inner ring body 410 and the outer ring body 420.

In some embodiments, as shown in FIG. 5, a connection between the first connecting rod 430 and the first inner ring edge 411 and a connection between the first connecting rod 430 and the first outer ring edge 421 may exhibit smooth transition connections. A connection between the second connecting rod 440 and the first inner ring edge 411 and a connection between the second connecting rod and 440 the first outer ring edge 421 may also exhibit smooth transition connections.

Specifically, the first connecting rod 430 is in a smooth transition connection with the first inner ring edge 411 through the first inner connecting portion 431 and is in a smooth transition connection with the first outer ring edge 421 through the first outer connecting portion 432. The second connecting rod 440 is in a smooth transition connection with the first inner ring edge 411 through the second inner connecting portion 441 and is in a smooth transition connection with the first outer ring edge 421 through the second outer connecting portion 442.

With this configuration,, the strengths of the connection between the first connecting rod 430 and the inner ring body 410 and the connection between the first connecting rod 430 and the outer ring body 420 can be improved, and the strengths of the connection between the second connecting rod 440 and the inner ring body 410 and the connection between the second connecting rod 420 and the outer ring body 420 can be improved, which can improve the bending resistance between the first connecting rod 430 and the second connecting rod 440 and can make the first connecting rod 430 and the second connecting rod 440 less susceptible to damage due to bending during elastic deformation, thereby improving the service life of the vibration transmission plate 400.

In some embodiments, the straight extending portion 433 is in a smooth transition connection with the first inner connecting portion 431 and the first outer connecting portion 432, the first inner connecting portion 431 is in a smooth transition connection with the first inner ring edge 411, and the first outer connecting portion 432 is in a smooth transition connection with the first outer ring edge 411. The curved extending portion 443 is in a smooth transition connection with the second inner connecting portion 441 and the second outer connecting portion 442, the second inner connecting portion 441 is in a smooth transition connection with the first inner ring edge 411, and the second outer connecting portion 442 is in a smooth connection transition with the first outer ring edge 421.

With this configuration,, the strength of the first connecting rod 430 and the second connecting rod 440 can be improved, thus improving the bending resistance of the first connecting rod 430 and the second connecting rod 440, thereby making the first connecting rod 430 and the second connecting rod 440 less prone to damage due to bending and improving the life of the vibration transmission plate 400.

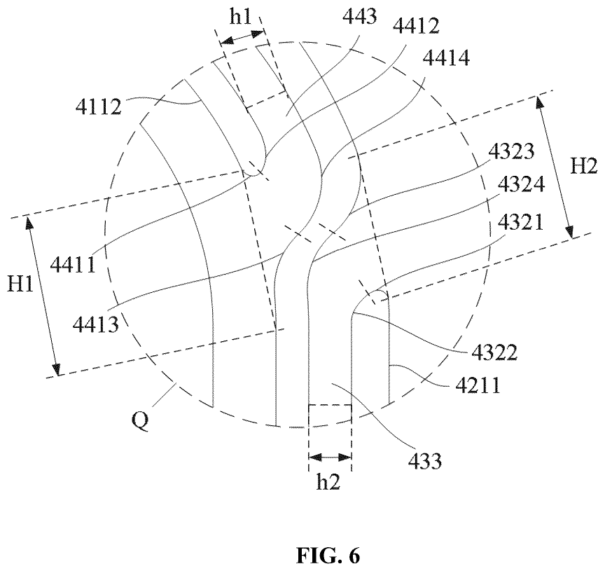

In some embodiments, the inner edge of the curved extending portion 443 may be arranged in a circular arc shape, as shown in FIG. 5 and FIG. 6. An inner edge of the second inner connecting portion 441 includes a first circular arc segment 4411 connected to the first inner ring edge 411 and a second circular arc segment 4412 that connects the first circular arc segment 4411 and the inner edge of the curved extending portion 443. The first circular arc segment 4411 and the second circular arc segment 4412 are connected at a position where the short dashed line is shown. The inner edge of the curved extending portion 443 refers to a side of the curved extending portion 443 that faces the first inner ring edge 411, and the inner edge of the second inner connecting portion 441 refers to an edge of the second inner connecting portion 441 that is connected to an edge of the first inner ring edge 411 that is relative to the inner edge of the curved extending portion 443, and is connected to the inner edge of the curved extending portion 443.

When the second connecting rod 440 undergoes elastic deformation, its internal stress tends to concentrate at the second inner connecting portion 441 and the inner edge of the curved extending portion 443. If the inner edge of the curved extending portion 443 and the second inner connecting portion 441 are formed into other shapes, for example, into an angled shape, then the stress of the second connecting rod 440 during elastic deformation may concentrate at the corner, thereby resulting in the vibration transmission plate 400 tearing from the corner more likely.

Therefore, by arranging the inner edge of the curved extending portion 443 in the circular arc shape, and the inner edge of the second inner connecting portion 441 in the shape of multiple arcs, the concentration of internal stress can be reduced when the curved extending portion 443 and the second inner connecting portion 441 undergo elastic deformation, which improves the bending resistance of the curved extending portion 443 and the second inner connecting portion 441 and makes they are less susceptible to damage during elastic deformation, thereby improving the reliability and service life of the vibration transmission plate 400.

It should be understood that, in other embodiments, the inner edge of the curved extending portion 443 and the inner edge of the second inner connecting portion 441 may also be configured in other shapes, such as wavy, folded, or the like, which are not specifically enumerated herein.

Optionally, as shown in FIG. 6, the first circular arc segment 4411 and the second circular arc segment 4412 may both be concave arcs. Setting both the first circular arc segment 4411 and the second circular arc segment 4412 to be concave arcs can make the inner edge of the second inner connecting portion 441 smoother, which realizes a natural transition between the curved extending portion 443 and the first inner ring edge 411, thereby enhancing the strength of the connection between the curved extending portion 443 and the inner ring body 410 connected through the second inner connecting portion 441.

Optionally, a ratio of a diameter of the first circular arc segment 4411 to a diameter of the curved extending portion 443 may be in a range of 0.02 to 0.03, and a ratio of a diameter of the second circular arc segment 4412 to the diameter of the inner edge of the curved extending portion 443 may be in a range of 0.11 to 0.14.

Specifically, if the ratio of the diameter of the first circular arc segment 4411 to the diameter of the inner edge of the curved extending portion 443 is greater than 0.03 and the ratio of the diameter of the second circular arc segment 4412 to the diameter of the inner edge of the curved extending portion 443 is greater than 0.14, the diameters of the first circular arc segment 4411 and the second circular arc segment 4412 may be too large, thereby making the distance between the inner edge of the curved extending portion 443 and the first inner ring edge 411 relatively large. In this case, the tensile force endured by the curved extending portion 443 may be increased when restraining the inner ring body 410, causing the curved extending portion 443 to be subject to a large stress and susceptible to deformation and fracture. If the ratio of the diameter of the first circular arc segment 4411 to the diameter of the inner edge of the curved extending portion 443 is less than 0.02 and the ratio of the diameter of the second circular arc segment 4412 to the diameter of the inner edge of the curved extending portion 443 is less than 0.11, then when the curved extending portion 443 and the second inner connecting portion 441 undergoes elastic deformation, the stress may be too concentrated at the second inner connecting portion 441, thus making the second inner connecting portion 441 susceptible to fracture.

Therefore, setting the ratio of the diameter of the first circular arc segment 4411 to the diameter of the inner edge of the curved extending portion 443 in the range of 0.02 to 0.03 and the ratio of the diameter of the second circular arc segment 4412 to the diameter of the inner edge of the curved extending portion 443 in the range of 0.11 to 0.14 can effectively disperse the stress of the curved extending portion 443 and the second inner connecting portion 441 while improving the vibration sensitivity of the vibration transmission plate 400, and reduce the concentration of stress, thus making the curved extending portion 443 and the second inner connecting portion 441 less likely to be fractured and damaged during the elastic deformation by improving their bending resistance.

For example, the ratio of the diameter of the first circular arc segment 4411 to the diameter of the inner edge of the curved extending portion 443 may be 0.0254, 0.0270, or 0.0285. The ratio of the diameter of the second circular arc segment 4412 to the diameter of the inner edge of the curved extending portion 443 may be 0.1095, 0.1168, or 0.121.

In some embodiments, an outer edge of the second inner connecting portion 441 may be opposite to the inner edge of the second inner connecting portion 441, as shown in FIG. 6. The outer edge of the second inner connecting portion 441 may include a third circular arc segment 4413 connected to the first inner ring edge 411 and a fourth circular arc segment 4414 that connects the third circular arc segment 4413 and the outer edge of the curved extending portion 443. The third circular arc segment 4413 and the fourth circular arc segment 4414 are connected at a position where the short dashed line is shown in FIG. 5. The outer edge of the curved extending portion 443 refers to a side of the curved extending portion 443 that faces the first outer ring edge 421, and the outer edge of the second inner connecting portion 441 refers to a side of the second inner connecting portion 441 that connects the first inner ring edge 411 and the outer edge of the curved extending portion 443.

Optionally, the third circular arc segment 4413 may be a concave arc, and the fourth circular arc segment 4414 may be a convex arc, as shown in FIG. 6. Setting the third circular arc segment 4413 as the concave arc enables a natural transition connection between the third circular arc segment 4413 and the first inner ring edge 411, and setting the fourth circular arc segment 4414 as the convex arc enables a natural transition connection between the fourth circular arc segment 4414 and the third circular arc segment 4413 and a natural transition connection between the fourth circular arc segment 4414 and the outer edge of the curved extending portion 443, thereby enhancing the strength of the connection between the curved extending portion 443 and the inner ring body 410 connected through the second inner connecting portion 441.

Optionally, a ratio of a diameter of the third circular arc segment 4413 to the diameter of the inner edge of the curved extending portion 443, and a ratio of a diameter of the fourth circular arc segment 4414 to the diameter of the inner edge of the curved extending portion 443 are both in a range of 0.16 to 0.2.

If the ratio of the diameter of the third circular arc segment 4413 to the diameter of the inner edge of the curved extending portion 443 and/or the ratio of the diameter of the fourth circular arc segment 4414 to the diameter of the inner edge of the curved extending portion 443 are greater than 0.2, then the distance between the curved extending portion 443 and the first inner ring edge 411 may be relatively large, which increases the tensile force to which the curved extending portion 443 is subjected when restraining the inner ring body 410, thereby causing the curved extending portion 443 to be subjected to a greater stress and prone to deformation and fracture. If the ratio of the diameter of the third circular arc segment 4413 to the diameter of the inner edge of the curved extending portion 443 and/or the ratio of the diameter of the fourth circular arc segment 4414 to the diameter of the inner edge of the curved extending portion 443 are less than 0.16, the connection between the outer edge of the second inner connecting portion 441 and the outer edge of the curved extending portion 443 may form a right-angled or acute-angled shape, and the connection between the outer edge of the second inner connecting portion 441 and the first inner ring edge 411 may form a right-angled or acute-angled shape. In such a case, when the curved extending portion 443 and the second inner connecting portion 441 undergo elastic deformation, the stress may be concentrated excessively at the second inner connecting portion 441, making the second inner connecting portion 441 prone to fracture. Therefore, setting the ratio of the diameter of the third circular arc segment 4413 to the diameter of the inner edge of the curved extending portion 443 and the ratio of the diameter of the fourth circular arc segment 4414 to the diameter of the inner edge of the curved extending portion 443 in the range of 0.16 to 0.2 can disperse the stress of the curved extending portion 443 and the second inner connecting portion 441, thereby improving the reliability of the vibration transmission plate 400.

For example, the ratio of the diameter of the third circular arc segment 4413 to the diameter of the inner edge of the curved extending portion 443, and the ratio of the diameter of the fourth circular arc segment 4414 to the diameter of the inner edge of the curved extending portion 443 may be 0.1732, 0.181, 0.1957, etc.

In some embodiments, the diameter of the fourth circular arc segment 4414 may be the same as the diameter of the third circular arc segment 4413. Such a configuration can make the stress of the third circular arc segment 4413 and the fourth circular arc segment 4414 more uniform when the second inner connecting portion 441 undergoes elastic deformation, thus increasing the strength of the connection between the curved extending portion 443 and the inner ring body 410 connected through the second inner connecting portion 441.

In some embodiments, a ratio of a straight-line distance from a connection point between the first circular arc segment 4411 and the first inner ring edge 411 to a connection point between the third circular arc segment 4413 and the first inner ring edge 411 to a width of the curved extending portion 443 may be in a range of 2.65 to 3.25.

The straight-line distance from the connection point between the first circular arc segment 4411 and the first inner ring edge 411 to the connection point between the third circular arc segment 4413 and the first inner ring edge 411 refers to a width of a connection position between the second inner connecting portion 441 and the first inner ring edge 411. Specifically, the straight-line distance from the connection point between the first circular arc segment 4411 and the first inner ring edge 411 to the connection point between the third circular arc segment 4413 and the first inner ring edge 411 may be as shown by the length H1 in FIG. 6, and the width of the curved extending portion 443 may be as shown by the length h1 in FIG. 6.

Setting the width of the connection between the second inner connecting portion 441 and the first inner ring edge 411 corresponding to the width of the curved extending portion 443 can make the strength of the connection between the second inner connecting portion 441 and the first inner ring edge 411 stronger.

Specifically, if the ratio of the straight-line distance from the connection point between the first circular arc segment 4411 and the first inner ring edge 411 to the connection point between the third circular arc segment 4413 and the first inner ring edge 411 to the width of the curved extending portion 443 is less than 2.65, this may make the connection between the second inner connecting portion 441 and the first inner ring edge 411 weak, and cause the second inner connecting portion 441 to be prone to fracture when undergoing elastic deformation. If the ratio of the straight-line distance from the connection point between the first circular arc segment 4411 and the first inner ring edge 411 to the connection point between the third circular arc segment 4413 and the first inner ring edge 411 to the width of the curved extending portion 443 is greater than 3.25, this may make the width of the connection between the second inner connecting portion 441 and the first inner ring edge 411 too large, and cause the second inner connecting portion 441 to excessively constrain the movement of the inner ring body 410, which will reduce the vibration sensitivity of the vibration transmission plate 400 and in turn reduce the sensitivity of the transducer device 11 and affect the bone-conduction effect of the bone-conduction earphone 1. Therefore, setting the ratio of the straight-line distance to the width of the curved extending portion 443 in the range of 2.65 to 3.25 can improve the sensitivity of the vibration transmission plate 400 while improving the bending resistance of the vibration transmission plate 400, thereby improving the reliability of the vibration transmission plate 400.

For example, in some embodiments, the ratio of the straight-line distance from the connection point between the first circular arc segment 4411 and the first inner ring edge 411 to the connection point between the third circular arc segment 4413 and the first inner ring edge 411 to the width of the curved extending portion 443 may be 2.78, 2.95, or 3.187.

In some embodiments, the second inner connecting portion 441 may be adjacent to the first outer connecting portion 432. As shown in FIG. 6, an outer edge of the first outer connecting portion 432 includes a fifth circular arc segment 4321 connected to the first outer ring edge 421 and a sixth circular arc segment 4321 that connects the fifth circular arc segment 4321 and an outer edge of the straight extending portion 433. The fifth circular arc segment 4321 and the sixth circular arc segment 4322 are connected at a position where the short dashed line is shown. The outer edge of the straight extending portion 433 refers to a side of the straight extending portion 433 that faces the first outer ring edge 421, and the outer edge of the first outer connecting portion 432 refers to a side of the first outer connecting portion 432 that connects an edge of the first outer ring edge 421 that is opposite to the outer edge of the straight extending portion 433 and the outer edge of the straight extending portion 433.

Optionally, the fifth circular arc segment 4321 and the sixth circular arc segment 4322 may be concave arcs, as shown in FIG. 6. Setting the fifth circular arc segment 4321 and the sixth circular arc segment 4322 as concave arcs can make the outer edge of the first outer connecting portion 432 smoother, thereby realizing a natural transition connection between the straight extending portion 433 and the first outer ring edge 421, enhancing the strength of the connection between the straight extending portion 433 and the outer ring body 420 connected through the first outer connecting portion 432.

Optionally, a ratio of a diameter of the fifth circular arc segment 4321 to the diameter of the inner edge of the curved extending portion 443 is in a range of 0.02 to 0.03, and a ratio of a diameter of the sixth circular arc segment 4322 to the inner edge of the curved extending portion 443 is in a range of 0.11 to 0.14.

Setting the diameters of the fifth circular arc segment 4321 and the sixth circular arc segment 4322 to correlate with the diameter of the inner edge of the curved extending portion 443 can cause the outer edge of the first outer connecting portion 432 to correspond to the second inner connecting portion 441. When both the first connecting rod 430 and the second connecting rod 440 are subjected to elastic deformation under force, the first connecting rod 430 and the second connecting rod 440 are subjected to comparable stress, and thus the stress can be evened out to ensure the reliability of the vibration transmission plate 400.

Specifically, if the ratio of the diameter of the fifth circular arc segment 4321 to the diameter of the outer edge of the curved extending portion 443 is greater than 0.03, and the ratio of the diameter of the sixth circular arc segment 4322 to the diameter of the outer edge of the curved extending portion 443 is greater than 0.14, then the diameters of the fifth circular arc segment 4321 and the sixth circular arc segment 4322 may be too large, making the distance between the straight extending portion 433 and the first outer ring edge 421 relatively large. In this way, the tensile force endured by the straight extending portion 433 may be increased, making the straight extending portion 433 subject to a large stress and susceptible to deformation and fracture. If the ratio of the diameter of the fifth circular arc segment 4321 to the diameter of the inner edge of the curved extending portion 443 is less than 0.02, and the ratio of the diameter of the sixth circular arc segment 4322 to the diameter of the inner edge of the curved extending portion 443 is less than 0.11, this may cause a connection between the outer edge of the first outer connecting portion 432 and the outer edge of the straight extending portion 433 to form a right-angled or acute-angled shape, and also cause a connection between the outer edge of the first outer connecting portion 432 and the first outer ring edge 421 to form to a right-angled or acute-angled shape. In this way, the stress will excessively concentrate on the first outer connecting portion 431 when the straight extending portion 433 and the first outer connecting portion 432 undergo elastic deformation, which makes the first outer connecting portion 432 prone to fracture and also increases the restraining force of the straight extending portion 433 on the inner ring body 410, thus affecting the vibration sensitivity of the vibration transmission plate 400.

Therefore, setting the ratio of the diameter of the fifth circular arc segment 4321 to the diameter of the outer edge of the curved extending portion 443 in the range of 0.02 to 0.03 and the ratio of the diameter of the sixth circular arc segment 4322 to the diameter of the outer edge of the curved extending portion 443 in the range of 0.11 and 0.14 can effectively disperse the stress at the first outer connecting portion 432, reduce the stress concentration, thereby improving the bending resistance of the straight extending portion 433 and the first outer connecting portion 432, thereby making them less prone to fracture and damage during elastic deformation.

For example, in some embodiments, the ratio of the diameter of the fifth circular arc segment 4321 to the diameter of the outer edge of the curved extending portion 443 may be 0.0254, 0.0270, or 0.0285. The ratio of the diameter of the sixth circular arc segment 4322 to the diameter of the outer edge of the curved extending portion 443 may be 0.1095, 0.1168, or 0.121.

In some embodiments, the diameter of the fifth circular arc segment 4321 may be the same as the diameter of the first circular arc segment 4411, and the diameter of the sixth circular arc segment 4322 may be the same as the diameter of the second circular arc segment 4412. Such a configuration can make the inner edge of the second inner connecting portion 441 and the outer edge of the first outer connecting portion 432 be the same, which enables the connection between the first connecting rod 430 and the inner ring body 410 and the connection between the second connecting rod 440 and the outer ring body 420 share the same stress, thereby reducing the problem of stress concentration between the first connecting rod 430 and the second connecting rod 440. Additionally, the connection position between the first connecting rod 430 and the inner ring body 410 and the connection position between the second connecting rod 440 and the outer ring body 420 are adjacent, which can reduce excessive stress concentration on the inner ring body 410 and the outer ring body 420 when being constrained by the first connecting rod 430 and the second connecting rod 440.

In some embodiments, as shown in FIG. 6, an inner edge of the first outer connecting portion 432 includes a seventh circular arc segment 4323 connected to the first outer ring edge 421 and an eighth circular arc segment 4323 that connects the seventh circular arc segment 4323 and an inner edge of the straight extending portion 433. The seventh circular arc segment 4323 and the eighth circular arc segment 4324 are connected at a position where the short dashed line is shown in FIG. 6. The inner edge of the straight extending portion 433 refers to a side of the straight extending portion 433 that faces the inner ring body 410, and the inner edge of the first outer connecting portion 432 refers to a side of the first outer connecting portion 432 that connects the inner edge of the straight extending portion 433 and the first outer ring edge 421.

The seventh circular arc segment 4323 may be a concave arc, and the eighth circular arc segment 4324 may be a convex arc. With this configuration, it is possible to make the inner edge of the first outer connecting portion 432 in a natural transition connection with the first outer ring edge 421 and the inner edge of the first outer connecting portion 432 in a natural transition connection with the inner edge of the straight extending portion 433, thereby improving the connection strength of the first inner connecting portion 432.

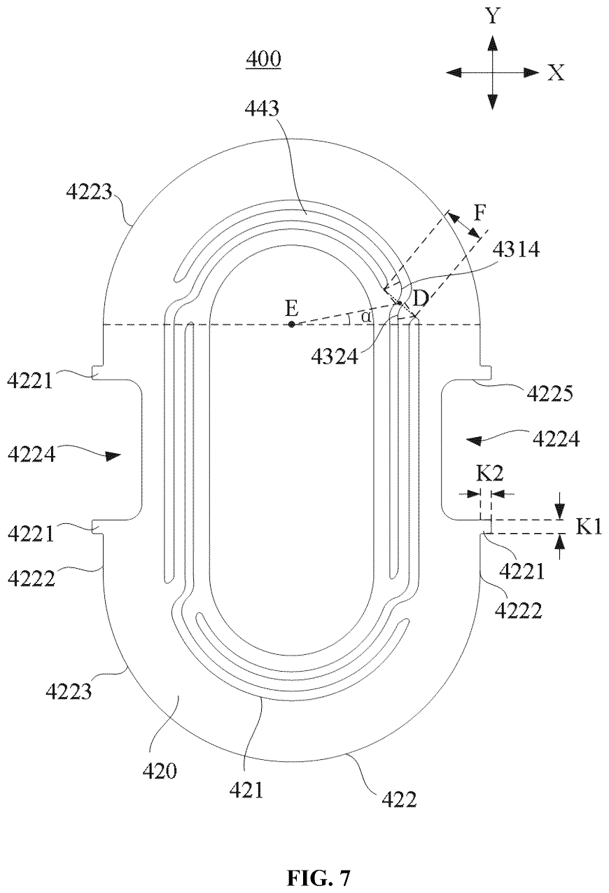

Optionally, as shown in FIG. 7, a connection line between a center of a circle of the fourth circular arc segment 4414 and a center of a circle of the eighth circular arc segment 4324 has a midpoint, and an angle formed between a connection line between the midpoint and a center of a circle of the inner edge of the curved extending portion 443 and a spacing direction between the two first straight line segments 4111 is in a range of 8 degrees to 18 degrees. The midpoint may be referred to as a midpoint D in FIG. 7, the center of the circle of the inner edge of the curved extending portion 443 may be referred to as a center of a circle E in FIG. 7, and the angle formed between the connection line between the midpoint D and the center of the circle E of the inner edge of the curved extending portion 443 and the spacing direction between the two first straight line segments 4111 may be referred to as an angle α in FIG. 7.

Specifically, the positions of the fourth circular arc segment 4414 and the eighth circular arc segment 4324 on the outer edge of the inner ring body 410 can be determined based on the angle α, and then the positions of the first inner connecting portion 431 and the second outer connecting portion 442 may be determined. Therefore, the configuration of the angle α allows for corresponding adjustments to the first inner connecting portion 431 and the second outer connecting portion 442. This adjustment, in turn, enables control over the positions, lengths, and stress states of the first connecting rod 430 and the second connecting rod 440. Thereby, the stress state of the vibration transmission plate 400 along the radial direction can be regulated, particularly in the stress states of the vibration transmission plate 400 along the spacing direction between the two first straight line segments 4111 and a spacing direction between the two first curved segments 4112.

Setting the angle α formed by the connection line between the midpoint of the connection line between the center of the circle of the fourth circular arc segment 4414 and the center of the circle eighth circular arc segment 4324 and the spacing direction between the two first straight line segments 4111 in the range of 8 degrees to 18 degrees can ensure that the stress on the first connecting rod 430 and the second connecting rod 440 more balanced, thereby reducing the phenomenon of stress concentration, and correspondingly balancing the stiffness of the vibration transmission plate 400 along the spacing direction between the two first straight line segments 4111 and the spacing direction between the two first curved segments 4112. If the angle α is less than 8 degrees or greater than 18 degrees, it will cause the stress to be too concentrated along the spacing direction between the two first straight line segments 4111 or the spacing direction between the two first curved segments 4112, and also reduce the stiffness along the other direction, which causes the vibration transmission plate 400 to be prone to fracture when the transducer device 11 is vibrating.

In some embodiments, the angle α may be in a range of 11 degrees to 15 degrees. With this configuration, the stress on the first connecting rod 430 and the second connecting rod 440 can more balanced while ensuring the stiffness of the vibration transmission plate 400 along all directions. For example, the angle α may be 12 degrees, 13 degrees, or 14 degrees, etc.

In some embodiments, a ratio of the connection length between the center of the circle of the fourth circular arc segment 4414 and the center of the circle of the eighth circular arc segment 4324 to the width of the curved extending portion 443 or a ratio of the connection length between the center of the circle of the fourth circular arc segment 4414 and the center of the circle of the eighth circular arc segment 4324 to the width of the straight extending portion 433 are in a range of 3.71 to 4.54. The connection length between the center of the circle of the fourth circular arc segment 4414 and the center of the circle of the eighth circular arc segment 4324 may be denoted by a length F in FIG. 7, and the width of the straight extending portion 433 may be denoted by a length h2 in FIG. 6.

As shown in FIG. 7, the distance between the center of the circle of the fourth circular arc segment 4414 and the center of the circle of the eighth circular arc segment 4324 relates to the radii of curvature of the two circular arc segments and a distance between the two circular arc segments. In turn, the radii of curvature of the fourth circular arc segment 4414 and the eighth circular arc segment 4324 also relate to the degree of transitional change where the first outer connecting portion 432 and the second inner connecting portion 441 connect the inner ring body 410 and the outer ring body 420. The connection length between the center of the circle of the fourth circular arc segment 4414 and the center of the circle of the eighth circular arc segment 4324 is designed to be related to the width of the curved extending portion 443 or the width of the straight extending portion 433, which allows adjustment of the degree of transitional change at the connection of the first outer connecting portion 432 to the inner ring body 410 and the outer ring body 420, the degree of transitional change at the connection of the second inner connecting portion 441 to the inner ring body 410 and the outer ring body 420. Furthermore, the distance between the first outer connecting portion 432 and the second inner connecting portion 441 can also be adjusted.

When the inner ring body 410 and the outer ring body 420 move relative to each other and the first connecting rod 430 and the second connecting rod 440 undergo elastic deformation, the stresses inside the first connecting rod 430 and the second connecting rod 440 are usually concentrated at the first outer connecting portion 432 and the second inner connecting portion 441. Therefore, by setting the radii of curvature of the fourth circular arc segment 4414 and the eighth circular arc segment 4324 to be related with the width of the curved extending portion 443 or the width of the straight extending portion 433, the stability at the first outer connecting portion 432 and the second inner connecting portion 441 can be correspondingly adjusted. In this way, the positions of stress reinforcement and concentration can be further controlled, so that the first outer connecting portion 432 and the second inner connecting portion 441 are less likely to fracture due to stress concentration, thereby enhancing the stability of the vibration transmission plate 400.

If the ratio of the connection length between the center of the circle of the fourth circular arc segment 4414 and the center of the circle of the eighth circular arc segment 4324 to the width of the curved extending portion 443 is less than 3.71or the ratio of the connection length between the center of the circle of the fourth circular arc segment 4414 and the center of the circle of the eighth circular arc segment 4324 to the width of the straight extending portion 433 is less than 3.71, this may result in the radii of curvature of the fourth circular arc segment 4414 and the eighth circular arc segment 4324 to be too small, or make the distance between the fourth circular arc segment 4414 and the eighth circular arc segment 4324 to be too small. Besides, when the first connecting rod 430 and the second connecting rod 440 undergo elastic deformation, the internal stresses tend to be concentrated at the second outer connecting portion 442 and the second inner connecting portion 441, which results in the first connecting rod 430 to be prone to fracture at the connection between the inner ring body 410 and the outer ring body 420, and also causes the second connecting rod 440 to be prone to fracture at the connection between the inner ring body 410 and the outer ring body 420.

If the ratio of the length of the connection between the center of the circle of the fourth circular arc segment 4414 and the center of the circle of the eighth circular arc segment 4324 to the width of the curved extending portion 443 is greater than 4.54 or the ratio of the length of the connection between the center of the circle of the fourth circular arc segment 4414 and the center of the circle of the eighth circular arc segment 4324 to the width of the straight extending portion 433 is greater than 4.54, this may result in the radii of curvature of the fourth circular arc segment 4414 and the eighth circular arc segment 4324 to be too large, or make the width of the connection between the second outer connecting portion 442 and the second inner connecting portion 441 to be relatively large, or make the distance between the fourth circular arc segment 4414 and the eighth circular arc segment 4324 too large. In this way, it would be unfavorable to the relative movement of the inner ring body 410 and the outer ring body 420, thereby affecting the vibration sensitivity of the vibration transmission plate 400.

Therefore, setting the ratio of the connection length between the center of the circle of the fourth circular arc segment 4414 and the center of the circle of the eighth circular arc segment 4324 to the width of the curved extending portion 443 or the ratio of the connection length between the center of the circle of the fourth circular arc segment 4414 and the center of the circle of the eighth circular arc segment 4324 to the width of the straight extending portion 433 in the range of 3.71 to 4.54 can maintain the vibration sensitivity of the vibration transmission plate 400 while reinforcing the strength of the connection between the second outer connecting portion 442 and the second inner connecting portion 441, thereby making the second outer connecting portion 442 and the second inner connecting portion 441 less susceptible to fracture due to stress concentration, and improving the solidity and reliability of the vibration transmission plate 400 by increasing its stiffness along the radial direction. For example, the ratio of the connection length between the center of the circle of the fourth circular arc segment 4414 and the center of the circle of the eighth circular arc segment 4324 to the width of the curved extending portion 443 or the ratio of the connection length between the center of the circle of the fourth circular arc segment 4414 and the center of the circle of the eighth circular arc segment 4324 to the width of the straight extending portion 433 may be 3.862, 4.12, or 4.374, etc.

In some embodiments, the width of the curved extending portion 443 may be in a range between the width of the straight extending portion 433 and the width of the inner ring body 410. With this configuration, the curved extending portion 443 may be less likely to affect the vibration sensitivity of the vibration transmission plate 400.

Optionally, in some embodiments, the width of the curved extending portion 443 may be the same as the width of the straight extending portion 433, and the width of the curved extending portion 443 and the width of the straight extending portion 433 may be both less than the width of the inner ring body 410, which can further ensure the vibration sensitivity of the vibration transmission plate 400. For example, the width of the curved extending portion 443 and the width of the straight extending portion 433 may both be 0.3 mm, 0.34 mm, 0.4 mm, or 0.45 mm.

In some embodiments, the ratio of the diameter of the seventh circular arc segment 4323 to the diameter of the inner edge of the curved extending portion 443 and the ratio of the diameter of the eighth circular arc segment 4324 to the diameter of the inner edge of the curved extending portion 443 are in a range of 0.16 to 0.2.

With this configuration, the shapes of the seventh circular arc segment 4323 and the eighth circular arc segment 4324 are similar to and correspond to the shapes of the third circular arc segment 4413 and the fourth circular arc segment 4414. Similarly, by setting the ratio of the diameter of the seventh circular arc segment 4323 to the diameter of the inner edge of the curved extending portion 443 and the ratio of the diameter of the eighth circular arc segment 4324 to the diameter of the inner edge of the curved extending portion 443 in the range of 0.16 to 0.2, the stress at the first outer connecting portion 432 can dispersed, thereby improving the reliability of the vibration transmission plate 400.

For example, the ratio of the diameter of the seventh circular arc segment 4323 to the diameter of the inner edge of the curved extending portion 443 and the ratio of the diameter of the eighth circular arc segment 4324 to the inner edge of the curved extending portion 443 may be 0.1732, 0.181, or 0.1957, etc.

In some embodiments, the diameters of the third circular arc segment 4413, the fourth circular arc segment 4414, the seventh circular arc segment 4323, and the eighth circular arc segment 4324 are the same. With this configuration, the first outer connecting portion 432 and the second inner connecting portion 441 can have similar shapes, such that when the first outer connecting portion 432 and the second inner connecting portion 441 undergo elastic deformation, the internal stress of the two connecting portions becomes more balanced, thereby reducing the difference in stress between them and improving the reliability and service life of the vibration transmission plate 400.

It should be understood that in other embodiments, the diameters of the third circular arc segment 4413, the fourth circular arc segment 4414, the seventh circular arc segment 4323, and the eighth circular arc segment 4324 may be set differently, or the diameters of the third circular arc segment 4413 and the fourth circular arc segment 4414 may be set to be the same, and the diameters of the seventh circular arc segment 4323 and the eighth circular arc segment 4324 may be set to be the same, which is not limited herein.

In some embodiments, as shown in FIG. 6, a straight-line distance from a connection point between the fifth circular arc segment 4321 and the first outer ring edge 421 to a connection point between the seventh circular arc segment 4323 and the first outer ring edge 421 is greater than the straight-line distance from the connection point between the first circular arc segment 4411 and the first inner ring edge 411 to the connection point between the third circular arc segment 4413 and the first inner ring edge 411.

Specifically, the straight-line distance from the connection point between the fifth circular arc segment 4321 and the first outer ring edge 421 to the connection point between the seventh circular arc segment 4323 and the first outer ring edge 421 is denoted by the length H2 in FIG. 6.

The straight-line distance from the connection point between the fifth circular arc segment 4321 and the first outer ring edge 421 to the connection point between the seventh circular arc segment 4323 and the first outer ring edge 421 is the width of a connection position between the first connecting rod 430 and the first outer ring edge 421. The straight-line distance from the connection point between the first circular arc segment 4411 and the first inner ring edge 411 to the connection point between the third circular arc segment 4413 and the first inner ring edge 411 is the width of a connection position between the second connecting rod 440 and the first inner ring edge 411.

Since the first outer ring edge 421 is located outside the first inner ring edge 411, when the inner ring body 410 and the outer ring body 420 move relative to each other, the movement of the first outer ring edge 421 may be greater, and therefore, a greater pulling force may be required to constrain the outer ring body 420. Therefore, by setting the straight-line distance from the connection point between the fifth circular arc segment 4321 and the first outer ring edge 421 to the connection point between the seventh circular arc segment 4323 and the first outer ring edge 421 to be greater than the straight-line distance from the connection point between the first circular arc segment 4411 and the first inner ring edge 411 to the connection point between the third circular arc segment 4413 and the first inner ring edge 411, the constraint as well as the connection strength oof the outer ring body 420 can be strengthen, thereby improving the reliability of the vibration transmission plate 400.

In some embodiments, the ratio of the straight-line distance from the connection point between the fifth circular arc segment 4321 and the first outer ring edge 421 to the connection point between the seventh circular arc segment 4323 and the first outer ring edge 421 to the width of the straight extending portion 433 is in a range of 3.17 to 3.88.

By setting the width of the connection between the first outer connecting portion 432 and the first outer ring edge 421 to correspond to the width of the straight extending portion 433, the connection between the first outer connecting portion 432 and the first outer ring edge 421 can be more precisely adjusted.

Specifically, if the ratio of the straight-line distance from the connection point between the fifth circular arc segment 4321 and the first outer ring edge 421 to the connection point between the seventh circular arc segment 4323 and the first outer ring edge 421 to the width of the straight extending portion 433 is less than 3.17, this makes the connection between the first outer connecting portion 432 and the first outer ring edge 421 relatively weak, and cause the first outer connecting portion 432 to be prone to fracture when undergoing elastic deformation. If the ratio of the straight-line distance from the connection point between the fifth circular arc segment 4321 and the first outer ring edge 421 to the connection point between the seventh circular arc segment 4323 and the first outer ring edge 421 to the width of the straight extending portion 433 is greater than 3.88, this will make the connection between the first outer connecting portion 432 and the first outer ring edge 421 too wide, and the first outer connecting portion 432 excessively constrains the movement of the inner ring body 410, which reduces the vibration sensitivity of the vibration transmission plate 400 and in turn reduces the sensitivity of the transducer device 11, thus affecting the bone-conduction effect of the bone-conduction earphone 1. Therefore, by setting the ratio of the straight-line distance H2 to the width of the straight extending portion 433 in the range of 3.17 to 3.88, the sensitivity of the vibration transmission plate 400 can improved while the stiffness of the vibration transmission plate 400 along the radial direction can ensured.

For example, the ratio of the straight-line distance from the connection point between the fifth circular arc segment 4321 and the first outer ring edge 421 to the connection point between the seventh circular arc segment 4323 and the first outer ring edge 421 to the width of the straight extending portion 433 may be 3.246, 3.52, or 3.751, etc.

In some embodiments, the first inner connecting portion 431 and the second outer connecting portion 442 may be arranged with reference to the shapes of the first outer connecting portion 432 and the second inner connecting portion 441 such that two ends of the first connecting rod 430 and the second connecting rod 440 are configured similarly. When the first connecting rod 430 and the second connecting rod 440 undergo elastic deformation, the stress difference between the two connecting rods can be reduced, thereby dispersing stress and reducing the likelihood of fracture of the vibration transmission plate 400, and thus improving the reliability and service life of the vibration transmission plate 400.

Based on the above structural configuration of the vibration transmission plate 400, a unidirectional load fatigue simulation can be performed on the vibration transmission plate 400, so as to study the distribution of stress and the number of fatigue failure cycles of the vibration transmission plate 400 under loads applied along the directions described above.

In some embodiments, the spacing direction between the two first straight line segments 4111 may be defined as a width direction of the vibration transmission plate 400 (i.e., the direction shown by the X-arrow in FIG. 6), the spacing direction between the two first curved segments 4112 may be defined as a length direction of the vibration transmission plate 400 (i.e., the direction shown by the Y-arrow in FIG. 6), and an axial direction of the vibration transmission plate 400 may be defined as a thickness direction of the vibration transmission plate 400, and the thickness direction of the vibration transmission plate 400 is perpendicular to the width direction and the length direction. Therefore, the loads to which the vibration transmission plate 400 is subjected during operation can be categorized according to the direction as a load along the width direction, a load along the length direction, an axial load (i.e., a load along the thickness direction of the vibration transmission plate 400), and a torsional load (a load that causes the vibration transmission plate 400 to overturn around the width direction).

FIG. 8 is a schematic diagram illustrating a stress distribution of the vibration transmission plate 400 under a load along the length direction. As shown in FIG. 8, when the vibration transmission plate 400 is subjected to a unidirectional load along the length direction, the second connecting rod 440 undergoes relatively large elastic deformation. The stress is concentrated on the two second connecting rods 440, and is distributed across the second inner connecting portion 441, the second outer connecting portion 442, and the curved extending portion 443 of the second connecting rod 440, instead of concentrating only on a single point.

Furthermore, in a fatigue simulation test, when the vibration transmission plate 400 is subjected to alternating stress along the length direction, the number of fatigue failure cycles of the vibration transmission plate 400 was determined to be 1.28×10⁸. Thus, the structural configuration of the two second connecting rods 440 can reduce the stress concentration when the vibration transmission plate 400 is subjected to a load along the length direction, thereby improving the stiffness of the vibration transmission plate 400 along the length direction and the service life of the vibration transmission plate 400.

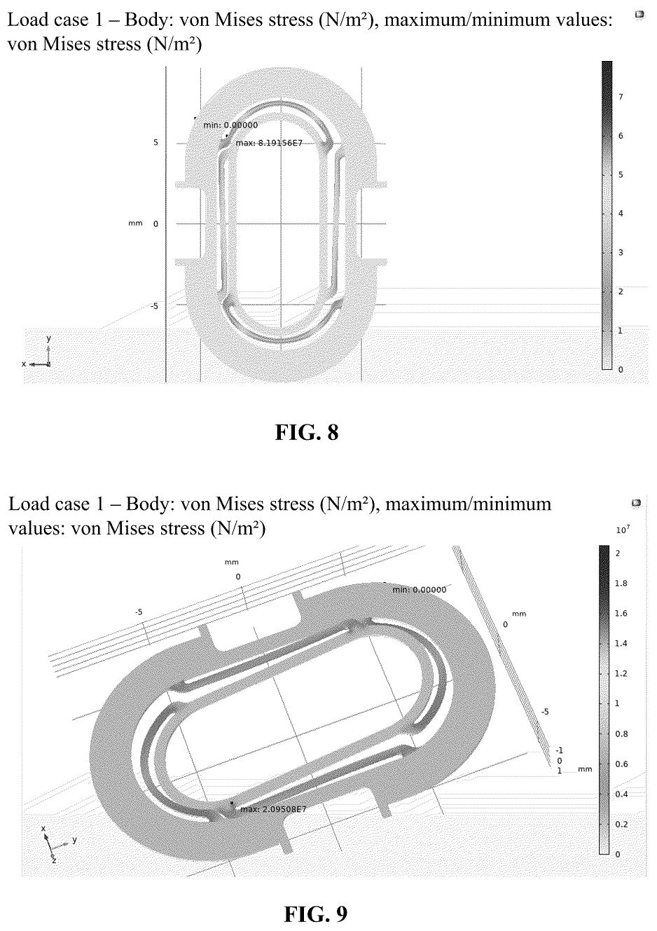

FIG. 9 is a schematic diagram illustrating a stress distribution of the vibration transmission plate 400 when subjected to a load along the width direction. As shown in FIG. 9, when the vibration transmission plate 400 is subjected to a unidirectional load along the width direction, the two first connecting rods 430 and the two second connecting rods 440 all undergo relatively large elastic deformation, and the stress is concentrated on the two first connecting rods 430 and the two second connecting rods 440, instead of concentrating only on a single point. Furthermore, in a fatigue simulation test, when the vibration transmission plate 400 is subjected to alternating stress along the width direction, the number of fatigue failure cycles of the vibration transmission plate 400 was determined to be 9.49E11.

As a result, when the vibration transmission plate 400 is subjected to the load along the width direction, each part of the two first connecting rods 430 and the two second connecting rods 440 can share the stresses to reduce the concentration of the stresses, thereby improving the stiffness of the vibration transmission plate 400 along the width direction and the service life of the vibration transmission plate 400.

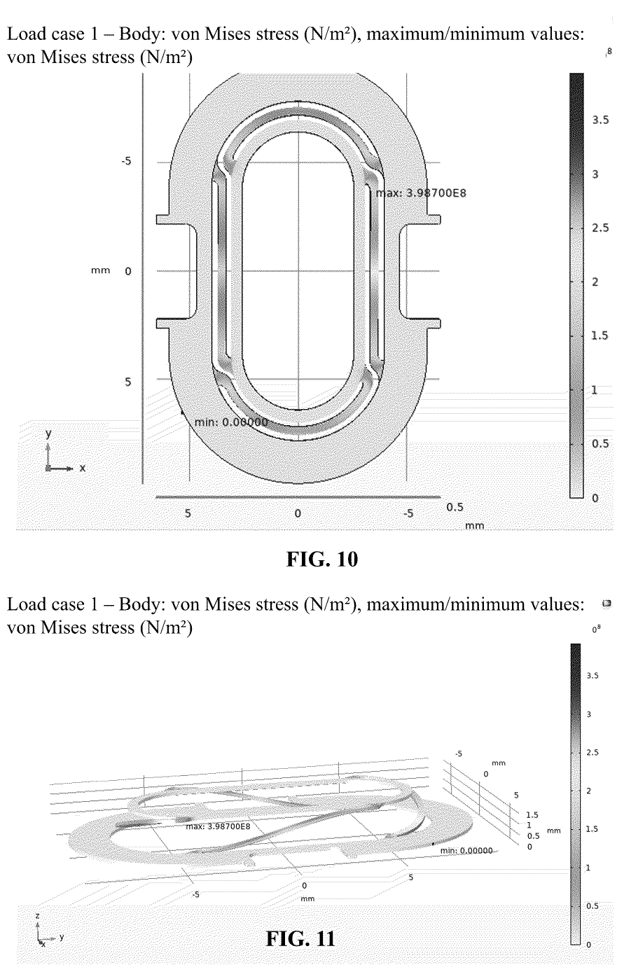

FIG. 10 and FIG. 11 are schematic diagrams illustrating a stress distribution of the vibration transmission plate 400 under an axial load along the axial direction. As shown in FIGS. 10 and 11, when the vibration transmission plate 400 is subjected to the axial load (i.e., the load along a direction perpendicular to the plane in which the vibration transmission plate 400 is located), after the two first connecting rods 430 and the two second connecting rods 440 undergo elastic deformation, and the stress thereof are distributed across various parts of the two first connecting rods 430 and the two second connecting rods 440 rather than being concentrated on a single point.

Furthermore, in a fatigue simulation test, when the vibration transmission plate 400 is subjected to alternating stress along the axial direction, the number of fatigue failure cycles of the vibration transmission plate 400 was determined to be 4.04E4.

During the normal operation of the bone-conduction earphone 1, when the bracket 200 on which the voice coil 100 is arranged and the magnetic circuit system 300 move relative to each other, the bracket 200 on which the voice coil 100 is arranged may drive the inner ring body 410 to move, and the magnetic circuit system 300 may drive the outer ring body 420 to move, and the load to which the vibration transmission plate 400 is subjected at this time is the axial load. Therefore, as can be seen in FIG. 10 and FIG. 11, during normal operation of the bone-conduction earphone 1, the stress of the vibration transmission plate 400 can be distributed across the various parts of the two first connecting rods 430 and the two second connecting rods 440, thereby improving the stiffness of the vibration transmission plate 400 along the radial direction and the reliability and service life of the vibration transmission plate 400.

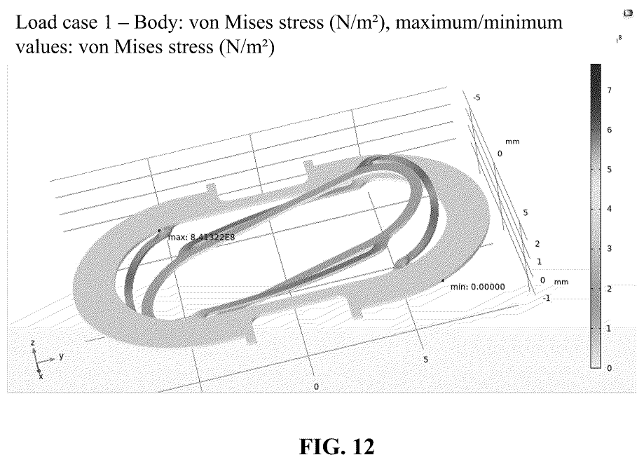

Since the bracket 200 is suspended in the middle of the magnetic circuit system 300 by the inner ring body 410, and the dimension of the vibration transmission plate 400 along the length direction is larger than the dimension along the width direction, the vibration transmission plate 400 is prone to experiencing a torsional load around the width direction during collisions or transportation of the bone-conduction earphone 1. As shown in FIG. 12, FIG. 12 is a schematic diagram illustrating a stress distribution of the vibration transmission plate 400 under a torsional load around the width direction.

When the vibration transmission plate 400 is subjected to a torsional load around the width direction, both of the first connecting rods 430 and both of the second connecting rods 440 undergo elastic deformation, and the stress in the first connecting rods 430 and the second connecting rods 440 is relatively evenly distributed across their respective parts.

Furthermore, in a fatigue simulation test in which the vibration transmission plate 400 is subjected to a torsional load around the width direction, the number of fatigue failure cycles of the vibration transmission plate 400 was determined to be 5.99E11. Therefore, when the vibration transmission plate 400 is subjected to the torsional load, the two first connecting rods 430 and the two second connecting rods 440 of the vibration transmission plate 400 can bear the stress more uniformly, thereby improving the service life of the vibration transmission plate 400.

As can be seen from the above description, the structural configuration of the vibration transmission plate 400 can effectively disperse the stress, reduce the concentration of stress and the occurrence of rupture, and improve the stiffness of the vibration transmission plate 400 along the radial direction as well as the axial direction, thereby improving the reliability and service life of the vibration transmission plate 400.

In some embodiments, as shown in FIG. 7, the outer ring body 420 includes the first outer ring edge 421 adjacent to the inner ring body 410 and a second outer ring edge 422 away from the inner ring body 410. A positioning protrusion 4221 may be arranged on the second outer ring edge 422, the positioning protrusion 4221 protruding toward the outside of the vibration transmission plate 400. In other words, the positioning protrusion 4221 is arranged on a side of the second outer ring edge 422 that is opposite to the inner ring body 410.

Specifically, by arranging the positioning protrusion 4221 on the second outer ring edge 422 and the positioning protrusion 4221 protruding toward the outside of the vibration transmission plate 400, the vibration transmission plate 400 can be positioned in a fixture used for assembling the transducer device 11 through the positioning protrusion 4221 during installation of the transducer device 11, thereby facilitating the subsequent installation of other components (such as the bracket 200 and the magnetic circuit system 300) on the vibration transmission plate 400. During the installation process, after the vibration transmission plate 400 is positioned on a fixture, it needs to be further connected with other components of the loudspeaker assembly 10. By providing the positioning protrusion 4221, the positioning accuracy of the vibration transmission plate 400 on the fixture can be improved, enabling more precise alignment with the fixture and reducing the likelihood of wobbling of the vibration transmission plate 400 in the fixture, thereby enhancing the assembly efficiency and assembly quality of the transducer device 11.

In some embodiments, as shown in FIG. 7, the second outer ring edge 422 includes two first sub-straight line segments 4222 and two first sub-curved segments 4223, the two first sub-straight line segments 4222 being arranged side-by-side and opposite to each other, and the two first sub-curved segments 4223 being respectively connected to adjacent ends of the two first sub-straight line segments 4222 and protruding toward the outside of the vibration transmission plate 400. Optionally, the two first sub-straight line segments 4222 may correspond to the two second straight line segments 4211 of the first outer ring edge 421, and the two first sub-curved segments 4223 may correspond to the two first curved segments 4112 of the first outer ring edge 421.

The positioning protrusion 4221 may be arranged on the first sub-straight line segments 4222. The positioning protrusion 4221 is arranged on the first sub-straight line segments 4222, not on the first sub-curved segments 4223. This configuration can facilitate the formation of the positioning protrusion 4221 since arranging the positioning protrusion 4221 on the first sub-curved segments 4223 is more difficult than arranging the positioning protrusion 4221 on the first sub-straight line segments 4222. Furthermore, the positioning protrusion 4221 arranged on the first sub-curved segments 4223 is required to undergo chamfering, so that the positioning protrusion 4221 can be disposed on the first sub-curved segment 4223 while minimizing the impact on the shape of first sub-straight line segment 4222.

It should be understood that, in other embodiments, the positioning protrusion 4221 may also be arranged on the first sub-curved segments 4223, which is not limited herein.

In some embodiments, a fist sub-straight line segment 4222 of the first sub-straight line segments 4222 may further be provided with a positioning groove 4224 recessed toward the inner ring body 410, as illustrated in FIG. 7. The positioning groove 4224 and the positioning protrusion 4221 are staggered from each other along the circumferential direction of the second outer ring edge 422. When viewing the transducer device 11 along the axis of the transducer device 11, the positioning groove 4224 can expose a portion of the magnetic circuit system 300, so that the portion of magnetic circuit system 300 is uncovered by the vibration transmission plate 400. The axis of the transducer device 11 may be perpendicular to the radial direction of the bracket 200 or parallel to the vibration direction of the bracket 200.

Optionally, as shown in FIG. 4, the transducer device 11 may further include a clamp 500 that may clamp an exposed portion of the magnetic circuit system 300 to make the magnetic circuit system 300 less likely to come apart during vibration, and the exposed portion of the magnetic circuit system 300 corresponds to the position of the positioning groove 4224. When viewing the transducer device 11 along the axis of the transducer device 11, the clamp 500 and the vibration transmission plate 400 are staggered from each other due to the positioning groove 4224, and thus the clamp 500 and the positioning groove 4221 are also spaced apart from each other.

In some embodiments, as shown in FIG. 7, the positioning protrusion 4221 may be arranged at an edge of the positioning groove 4224. When viewed along the thickness direction of the vibration transmission plate 400, an edge of the positioning protrusion 4221 close to the positioning groove 4224 and a groove wall of the positioning groove 4224 are located on a straight line and form a first straight line 4225. In this way, the positioning protrusion 4221 is arranged on the groove wall of the positioning groove 4224, to facilitate the formation of the positioning protrusion 4221, and the positioning groove 4224 can be utilized to locate and add the positioning protrusion 4221 to reduce the processing difficulty of the vibration transmission plate 400.

It should be understood that in other embodiments, the positioning protrusion 4221 may be located at other positions of the first sub-straight line segments 4222, for example, it may be located at a distance of 1 cm or at a distance of 0.5 cm from the positioning groove 4224, or the like, which is not specifically enumerated herein.

In some embodiments, the first straight line 4225 may be perpendicularly to the first sub-straight line segments 4222, as shown in FIG. 7. Such a configuration not only facilitates the formation of the positioning groove 4224 and the positioning protrusion 4221, but also enables the positioning groove 4224 to further constrain the magnetic circuit system 300 by constraining the clamp 500, thereby making the magnetic circuit system 300 less prone to misalignment.

In some embodiments, the positioning protrusion 4221 may be arranged in a rectangular shape, as shown in FIG. 7. Optionally, one edge of the rectangular positioning protrusion 4221 is connected and fixed to the first outer ring edge 421, and the remaining three edges extend beyond the first outer ring edge 421 for cooperating with the fixture for assembling the transducer device 11. The rectangular positioning protrusion 4221 is easy to mold, and can also easily improve positioning accuracy.

It should be understood that in other embodiments, the positioning protrusion 4221 may also be round, conical, or other shapes, which are not specifically enumerated herein.

In some embodiments, as shown in FIG. 7, there are two positioning protrusions 4221 arranged on two sides of the positioning groove 4224, respectively. Setting a plurality of positioning protrusions 4221 can further improve the positioning accuracy, and also allow the positioning protrusions 4221 themselves to be intentionally broken off and damaged in the process of cooperating with the fixture for positioning.

In some embodiments, as shown in FIG. 7, there are two groups of positioning grooves 4224 and two groups of positioning protrusions 4221, and one group of positioning groove(s) 4224 and one group of positioning protrusions 4221 are arranged on each of the two first sub-straight line segments 4222, respectively.

Optionally, the two groups of positioning grooves 4224 may be arranged in an axially symmetric manner and the two groups of positioning protrusions 4221 may be arranged in an axially symmetric manner, so as to enable positioning in cooperation with a fixture on two sides along the spacing direction between the two first sub-straight line segments 4222, thereby further improving the positioning accuracy.

For example, as shown in FIG. 7, one group of positioning grooves 4224 may include one positioning groove 4224, and one group of positioning protrusions 4221 may include two positioning protrusions 4221. For a positioning groove 4224, two positioning protrusions 4221 are located on two sides of the positioning groove 4224, respectively, and one edge of each of the two positioning protrusions 4221, which is adjacent to the positioning groove 4224, naturally transitions from the groove wall of the positioning groove 4224, and the edges of the two positioning protrusions 4221 and the corresponding groove walls lie on the same straight lines.

Optionally, for each of the first sub-straight line segments 4222, the corresponding group of positioning grooves 4224 and group of positioning protrusions 4221 are centrally arranged relative to the first sub-straight line segment 4222 along the extension direction of the first sub-straight line segment 4222. Setting the positioning groove 4224 and the positioning protrusions 4221 to be centrally arranged on the first sub-straight line segment 4222 not only facilitates positioning and the formation of the positioning groove 4224 and the positioning protrusions 4221, but also allows the vibration transmission plate 400 to subject to a balanced force when assembling the transducer device 11, so that the length of the first sub-straight line segment 4222 can be reduced, which in turn reduces the dimension of the vibration transmission plate 400.

In some embodiments, a protrusion length of each positioning protrusion 4221 relative to the second outer ring edge 422 is in a range of 0.315 mm to 0.385 mm, and a protrusion width of each positioning protrusion 4221 relative to the second outer ring edge 422 is in a range of 0.378 mm to 0.462 mm. The protrusion length of each positioning protrusion 4221 relative to the second outer ring edge 422 is shown by a length K1 in FIG. 7, and the protrusion width of each positioning protrusion 4221 relative to the second outer ring edge 422 is shown by a length K2 in FIG. 7.

Specifically, if the protrusion length of each positioning protrusion 4221 relative to the second outer ring edge 422 is less than 0.315 mm, the positioning protrusion 4221 is unlikely to properly engage with the fixture for positioning, resulting in insufficient positioning accuracy. If the protrusion length of each positioning protrusion 4221 relative to the second outer ring edge 422 is greater than 0.385 mm, the dimension of the transducer device 11 will be affected, and when the transducer device 11 is assembled in the loudspeaker assembly 10, more space needs to be reserved to accommodate the longer positioning protrusion 4221, which will affect the dimension of earphones. By setting the protrusion length of each positioning protrusion 4221 relative to the second outer ring edge 422 in the range of 0.315 mm to 0.385 mm, the positioning accuracy of the vibration transmission plate 400 can be improved while maintaining a relatively narrow dimension along the spacing direction between the two first sub-straight line segments 4222.

Similarly, if the protrusion width of each positioning protrusion 4221 relative to the second outer ring edge 422 is less than 0.378 mm, the positioning protrusion 4221 is unlikely to properly engage with the fixture for positioning, resulting in insufficient positioning accuracy. If the protrusion width of each positioning protrusion 4221 relative to the second outer ring edge 422 is greater than 0.462 mm, the length of the first sub-straight line segment 4222 will be affected. By setting the protrusion width of each positioning protrusion 4221 relative to the second outer ring edge 422 in the range of 0.378 mm to 0.462 mm, the positioning accuracy of the vibration transmission plate 400 can be improved while maintaining a relatively narrow dimension along the spacing direction between the two first sub-straight line segments 4222.

For example, the protrusion length of each positioning protrusion 4221 relative to the second outer ring edge 422 may be 0.325 mm, 0.35 mm, or 0.375 mm, and the protrusion width relative to the second outer ring edge 422 may be 0.395 mm, 0.42 mm, or 0.457 mm.

In summary, the first connecting rod 430 and the second connecting rod 440 are connected to the inner ring body 410 and the outer ring body 420, and both the first connecting rod 430 and the second connecting rod 440 are connected to the inner ring body 410 at one end and the outer ring body 420 at the other end. The first connecting rod 430 is arranged in the straight gap 401 between the inner ring body 410 and the outer ring body 420, and the first connecting rod 430 is provided with the straight extending portion 433 corresponding to the straight gap 401 as well as the linear shapes of the inner ring body 410 and the outer ring body 420. The second connecting rod 440 is arranged in the curved gap 402 between the inner ring body 410 and the outer ring body 420, and the second connecting rod 440 is provided with the curved extending portion 443 corresponding to the curved gap 402 as well as the curved shapes of the inner ring body 410 and the outer ring body 420. Therefore, the design of the first connecting rod 430 and the second connecting rod 440 corresponding to the shapes of the inner ring body 410 and the outer ring body 420 allows the inner ring body 410 to move relative to the outer ring body 420 while maintaining the sensitivity of their relative movement, and at the same time increases lateral stiffness, so that the first connecting rod 430 and the second connecting rod 440 are less likely to fracture, thereby improving the reliability of the vibration transmission plate 400 and enhancing its service life.

The above description is only part of the embodiments of the present disclosure and is not intended to limit the scope of protection of the present disclosure. Any equivalent devices or equivalent process variations made based on the present disclosure, or directly or indirectly applied in other related technical fields, are similarly included within the scope of the patent protection of the present disclosure.

What is claimed is:

1. A vibration transmission plate, comprising an inner ring body, an outer ring body surrounding the inner ring body, and a first connecting rod and a second connecting rod connected between the inner ring body and the outer ring body, wherein
the inner ring body includes a first inner ring edge adjacent to the outer ring body, the first inner ring edge includes two first straight line segments and two first curved segments, the two first straight line segments are arranged side by side and opposite to each other, and the two first curved segments are respectively connected to adjacent ends of the two first straight line segments and protrude toward an outside of the vibration transmission plate; the outer ring body includes a first outer ring edge adjacent to the inner ring body, the first outer ring edge includes two second straight line segments respectively located outside the two first straight line segments and two second curved segments respectively located outside the two first curved segments, such that a straight gap is formed between each pair of adjacent first straight line segment and second straight line segment, and a curved gap is formed between each pair of adjacent first curved segment and second curved segment;
the first connecting rod includes a first inner connecting portion connected to the first inner ring edge, a first outer connecting portion connected to the first outer ring edge, and a straight extending portion connected between the first inner connecting portion and the first outer connecting portion and located within the straight gap; and
the second connecting rod includes a second inner connecting portion connected to the first inner ring edge, a second outer connecting portion connected to the first outer ring edge, and a curved extending portion connected between the second inner connecting portion and the second outer connecting portion and located within the curved gap.

2. The vibration transmission plate of claim 1, wherein there are two first connecting rods and two second connecting rods, and the two first connecting rods and the two second connecting rods are 180 degrees rotationally symmetrical relative to a centroid or center of mass of the inner ring body.

3. The vibration transmission plate of claim 1, wherein the first inner connecting portion is adjacent to the second outer connecting portion, and the first outer connecting portion is adjacent to the second inner connecting portion.

4. The vibration transmission plate of claim 1, wherein the first curved segment, the second curved segment, and an inner edge and an outer edge of the curved extending portion are arranged in circular arc shapes with a common center of a circle, and the first straight line segment, the second straight line segment, and an inner edge and an outer edge of the straight extending portion are arranged parallel to each other.

5. The vibration transmission plate of claim 1, wherein an inner edge of the curved extending portion is arranged in a circular arc shape, an inner edge of the second inner connecting portion includes a first circular arc segment connected to the first inner ring edge and a second circular arc segment that connects the first circular arc segment and the inner edge of the curved extending portion,
a ratio of a diameter of the first circular arc segment to a diameter of the inner edge of the curved extending portion is in a range of 0.02 to 0.03,
a ratio of a diameter of the second circular arc segment to the diameter of the inner edge of the curved extending portion is in a range of 0.11 to 0.14, and
the first circular arc segment and the second circular arc segment are concave arcs.

6. The vibration transmission plate of claim 5, wherein an outer edge of the second inner connecting portion includes a third circular arc segment connected to the first inner ring edge and a fourth circular arc segment that connects the third circular arc segment and an outer edge of the curved extending portion,
a ratio of a diameter of the third circular arc segment to the diameter of the inner edge of the curved extending portion is in a range of 0.16 to 0.2,
a ratio of a diameter of the fourth circular arc segment to the diameter of the inner edge of the curved extending portion is in a range of 0.16 to 0.2,
the third circular arc segment is a concave arc, and
the fourth circular arc segment is a convex arc.

7. The vibration transmission plate of claim 6, wherein the diameter of the fourth circular arc segment is the same as the diameter of the third circular arc segment.

8. The vibration transmission plate of claim 6, wherein a ratio of a straight-line distance from a connection point between the first circular arc segment and the first inner ring edge to a connection point between the third circular arc segment and the first inner ring edge to a width of the curved extending portion is in a range of 2.65 to 3.25.

9. The vibration transmission plate of claim 6, wherein the second inner connecting portion is adjacent to the first outer connecting portion,
an outer edge of the first outer connecting portion includes a fifth circular arc segment connected to the first outer ring edge and a sixth circular arc segment that connects the fifth circular arc segment and an outer edge of the straight extending portion,
a ratio of a diameter of the fifth circular arc segment to the diameter of the inner edge of the curved extending portion is in a range of 0.02 to 0.03,
a ratio of a diameter of the sixth circular arc segment to the diameter of the inner edge of the curved extending portion is in a range of 0.11 to 0.14, and
the fifth circular arc segment and the sixth circular arc segment are concave arcs.

10. The vibration transmission plate of claim 9, wherein the diameter of the fifth circular arc segment is the same as the diameter of the first circular arc segment, and
the diameter of the sixth circular arc segment is the same as the diameter of the second circular arc segment.

11. The vibration transmission plate of claim 9, wherein an inner edge of the first outer connecting portion includes a seventh circular arc segment connected to the first outer ring edge and an eighth circular arc segment that connects the seventh circular arc segment and an inner edge of the straight extending portion,
a connection line between a center of a circle of the fourth circular arc segment and a center of a circle of the eighth circular arc segment has a midpoint,
an angle formed between a connection line between the midpoint and a center of a circle of the inner edge of the curved extending portion and a spacing direction between the two first straight line segments is in a range of 8 degrees to 18 degrees,
the seventh circular arc segment is a concave arc, and
the eighth circular arc segment is a convex arc.

12. The vibration transmission plate of claim 11, wherein a ratio of a connection length between the center of the circle of the fourth circular arc segment and the center of the circle of the eighth circular arc segment to a width of the curved extending portion or a width of the straight extending portion is in a range of 3.71 to 4.54, or
a ratio of a diameter of the seventh circular arc segment to the diameter of the inner edge of the curved extending portion is in a range of 0.16 to 0.2, and a ratio of a diameter of the eighth circular arc segment to the diameter of the inner edge of the curved extending portion is in a range of 0.16 to 0.2.

13. The vibration transmission plate of claim 11, wherein a straight-line distance from a connection point between the fifth circular arc segment and the first outer ring edge to a connection point between the seventh circular arc segment and the first outer ring edge is greater than a straight-line distance from a connection point between the first circular arc segment and the first inner ring edge to a connection point between the third circular arc segment and the first inner ring edge.

14. The vibration transmission plate of claim 1, wherein a connection between the first connecting rod and the first inner ring edge and a connection between the first connecting rod and the first outer ring edge are smooth transition connections; and
a connection between the second connecting rod and the first inner ring edge and a connection between the second connecting rod and the first outer ring edge are smooth transition connections.

15. The vibration transmission plate of claim 1, wherein the outer ring body includes the first outer ring edge adjacent to the inner ring body and a second outer ring edge away from the inner ring body; and
a positioning protrusion is arranged on the second outer ring edge, and the positioning protrusion protrudes toward the outside of the vibration transmission plate.

16. The vibration transmission plate of claim 15, wherein
the second outer ring edge includes two first sub-straight line segments and two first sub-curved segments,
the two first sub-straight line segments are arranged side by side and opposite to each other,
the two first sub-curved segments are respectively connected to adjacent ends of the two first sub-straight line segments and protrude toward the outside of the vibration transmission plate; and
the positioning protrusion is arranged on the first sub-straight line segments.

17. The vibration transmission plate of claim 16, wherein a first sub-straight line segment of the first sub-straight line segments is further provided with a positioning groove recessed toward the inner ring body; and
the positioning groove and the positioning protrusion are staggered from each other along a circumferential direction of the second outer ring edge.

18. The vibration transmission plate of claim 15, wherein a protrusion length of each positioning protrusion relative to the second outer ring edge is in a range of 0.315 mm to 0.385 mm, and a protrusion width of each positioning protrusion relative to the second outer ring edge is in a range of 0.378 mm to 0.462 mm.

19. A loudspeaker assembly, comprising a transducer device, wherein
the transducer device includes a voice coil, a bracket, a magnetic circuit system, and the vibration transmission plate of claim 1,
the inner ring body of the vibration transmission plate is connected to the bracket,
the outer ring body of the vibration transmission plate is connected to the magnetic circuit system to elastically suspend the magnetic circuit system on a periphery of the bracket, and
the voice coil is arranged on the bracket.

20. A bone-conduction earphone, comprising the vibration transmission plate of claim 1.
